(19) United States
(12) Patent Application Publication
(10) Pub. No.: US 2012/0077533 A1
(43) Pub. Date: Mar. 29, 2012

(54) Method and Network Device for Managing Resource Allocation

(76) Inventors: Ralf Irmer, Newbury (GB); Bernhard Raaf, Neuried (DE); Simone Redana, Munich (DE); David Lister, Berkshire (GB)

(21) Appl. No.: 13/202,117

(22) PCT Filed: Feb. 20, 2009
(86) PCT No.: PCT/EP2009/052035

§ 371 Date: Dec. 5, 2011

(51) Int. Cl. H04W 52/04; H04W 72/04; H04B 7/24

(52) U.S. Cl. 455/509

(57) ABSTRACT

A method and network device for managing resource allocation in at least one network device of a plurality of network devices in a mobile telecommunications network including the steps of: determining at least one energy dependent parameter in relation to each of the at least one network devices; and using the at least one determined energy-dependent parameter to make a resource allocation determination.

### FIELD OF THE INVENTION

The present invention relates to a method of implementing control in a communications network particularly a telecommunications network. The invention also relates to modular radio network elements, such as micro base stations, for use in such a telecommunications network, and in particular a method of managing radio resources in a network incorporating such modular radio network elements. More particularly the present invention relates to a method and associated system for managing handover between network elements.

### SUMMARY OF THE INVENTION

There have recently been proposals to allow access to the features and services provided by wireless networks, using standards such as GSM (Global System for Mobile Communications), UMTS (Universal Mobile Telecommunications System), HSPA (High Speed Packet Access), cdma2000 (Code Division Multiple Access 2000), WiFi and WiMAX (Worldwide Interoperability for Microwave Access), other than by accessing those networks in the conventional manner. In this regard, the conventional manner is by signalling between a mobile terminal and a conventional base station (macro base station) that has a dedicated connection to a Mobile Switching Centre (MSC). These macro base stations are typically deployed on masts, towers or roof-tops, where a power supply is readily available.

However, there are trends towards providing network access using modular network elements, such as Micro base stations, Pico base stations, Femto base stations, repeaters and relay stations. In this regard, “modular” is intended to refer to smaller “plug in” network elements that can be added to make the network larger, provide network capacity, provide network coverage, fill coverage holes or provide coverage in emergency situations or during network build-out. These modular radio network elements can be deployed on a more extensive basis, particularly due to their size, and accordingly can be deployed on lamp posts, on building walls and inside/outside customer premises. They can be used in relation to current as well as emerging wireless network standards, including WiMAX, 3GPP LTE (3rd Generation Partnership Project Long Term Evolution), 3GPP LTE-Advanced, mobile WiMAX, Ultra Mobile Broadband (UMB), IEEE 802.16j, IEEE 802.16m and also WLAN and Wireless mesh networks.

Access points (APs), is a generic name given to the smaller base stations (BSs) that are typically provided at a subscriber's home or office. As indicated above, many different names have been given to APs, such as home access points (HAPs), micro-base stations, pico-base stations, pico-cells and femto-cells, but all names refer to the same network device. APs provide short range, localized cellular telecommunications coverage, and are typically purchased by, or rented to, a subscriber to be installed in their house or business premises, and are intended to increase network coverage and capacity.

These APs may be dedicated network access points, or may be enhanced wireless internet hubs (i.e. providing wireless internet access, as well as wireless telecommunications network access). The range of APs is significantly smaller than macro base stations, typically only providing coverage of the order of 20 to 30 metres.

An advantage of introducing APs in existing telecommunications networks is that, where sufficient numbers of APs are implemented, the power level of the macro coverage could be reduced, due to a lower demand for the macro-base stations. Power reductions of course result in energy and financial savings, for instance due to less spectrum or less base station deployments being required and also less hardware.

A further advantage of using an access point connected to the core network via an IP (Internet Protocol) network is that existing broadband Digital Subscriber Line (DSL) connections can be used to link mobile terminals with the network core without using the capacity of the radio access network or transmission network of a mobile telecommunications network. In other words, the AP is be integrated into a DSL modem/router and uses DSL to backhaul the traffic to the communication network.

A still further advantage is that APs are able to provide mobile network access to areas where there is no macro radio access network coverage. For example, an AP could provide 3G coverage in an area where there is no macro 3G coverage at all, perhaps only macro GSM coverage. The use of APs as an additional or alternative means for accessing the network therefore advantageously increases the network coverage and capacity.

However, additional challenges arise in implementing modular radio network elements, such as access points, repeaters and relay stations in a well-integrated and efficient communications network. For instance, since these modular network elements may not be under the direct influence of a telecommunication network provider, it may not be possible for the network provider to fully rely on these modular radio network elements since the network provider may not have full control over the connection of the network elements to the network or of their maintenance.

One example of the possible unreliability of these modular network elements is in relation to their power supply. Particularly depending upon their location, power to the modular base stations may only be available unreliably or in a certain period of the day. For example where the network element is located on a lamp post, it may only have an electricity supply during the night time. Similarly, in remote locations or developing countries, the power supply may be intermittent or only available for a certain number of hours a day. Macro base station usually have a backup power supply based on batteries or diesel generators, however this is generally not technically or economically feasible for most small modular radio network elements.

Similar problems apply where the network elements are implemented using alternative energy sources, such as solar panels or wind turbines. These technologies are dependent on the elements, and therefore not necessarily totally reliable.

There is therefore a need to provide an improved communication environment and particularly improved radio resource management in a communications network.

With the present invention, the above mentioned issues are resolved. The technique is achieved by the teachings contained in the independent method claim 1 and in the independent network device claim 5.

Said independent method claim manages the resource allocation in at least one network device of a plurality of network devices in a mobile telecommunications network comprising the steps of:
determining at least one energy dependent parameter in relation to each of the at least one network devices; and
using the at least one determined energy-dependent parameter to make a resource allocation determination.

Said independent network device claim has means that are arranged to execute the method steps of claim 1.

Further advantageous embodiments can be seen in the dependent claims. Wherein:

The inventive technique further comprises the steps of:
determining at least one network traffic dependent parameter; and
using the at least one determined network traffic dependent parameter to make the resource allocation determination.

Wherein the determined energy dependent parameter comprises at least one of:

a) an energy consumption parameter relating to each network device;

b) an energy cost parameter relaying to each network device's energy source;

c) an energy reliability factor relating to each network device's energy source.

Wherein the determined energy dependent parameter comprises at least one of:

a) a power level of a battery of each network device;

b) an energy reliability classification for each network device;

c) a cost of energy supplied to each network device;

d) an estimated future power supply for each network device;

e) an average power consumption of each network device;

f) a peak power consumption of each network device;

g) an estimated energy consumption for different operational modes of each network device;

h) an estimated energy consumption for different quality of services that a user can require

i) an estimated energy consumption required to serve one or more particular users; and

l) an estimated energy consumption pattern over a given time period for each network device.

### SHORT DESCRIPTION OF THE DRAWINGS

The present invention will become more fully understood from the description given herein below and the accompanying drawings which are given by way of illustration only and thus are not limitative of the present invention, and wherein:

FIG. 1 illustrates an example of a mobile telecommunications network comprising an access point in addition to a conventional base station, in which the embodiments of the present invention may be implemented.

FIGS. 2 and 3 illustrate an example of a telecommunications network comprising different relay elements, useful in describing illustrative embodiments of the invention.

### DETAILED DESCRIPTION OF THE INVENTION

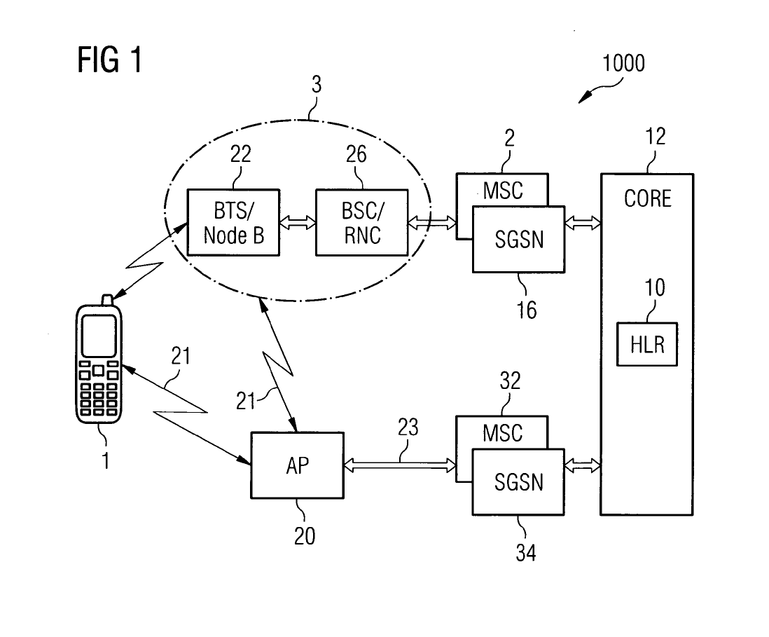

A mobile telecommunications network 1000, and its operation, will now be described with reference to FIG. 1.

Each base station (BS) 3 and access point (AP) 20 correspond to a respective cell of the cellular or mobile telecommunications network and receives calls from and transmits calls to a mobile terminal (MT) or user equipment (UE) 1, in that cell, by wireless radio communication in one or both of the circuit switched or packet switched domains. The MT 1 may be any portable telecommunications device, including a handheld mobile telephone, a personal digital assistant (PDA) or a laptop computer equipped with a network access datacard.

When mobile telecommunications network 1000 uses GSM technology, each BS 3 comprises of a base transceiver station (BTS) 22 and a base station controller (BSC) 26. A BSC may control more than one BTS. The BTSs and BSCs comprise the radio access network (RAN).

When mobile telecommunications network 1000 uses UMTS technology, each BS 3 comprises a nodeB 22 and a radio network controller (RNC) 26. An RNC may control more than one nodeB. The nodeBs and RNCs comprise the radio access network (RAN).

In the proposed LTE mobile telecommunications network, each

BS 3 comprises an enhanced NodeB (eNodeB), which effectively combines the functionality of the nodeB and the RNC of the UMTS network.

Conventionally, in a GSM/UMTS network, the base stations are arranged in groups and each group of base stations is controlled by a mobile switching centre (MSC) 2 and an SGSN (Serving GPRS Support Node) 16. MSC 2 supports communications in the circuit switched domain—typically voice calls, and corresponding SGSN 16 supports communications in the packet switched domain—such as GPRS (General Packet Radio Service) data transmissions. SGSN 16 functions in an analogous way to MSC 2. The BS 3 has a dedicated (not shared) connection to its MSC 2, typically over a cable connection. This prevents transmission speeds being reduced due to congestion caused by other traffic.

In the proposed LTE network, it is envisaged that the base stations will be arranged in groups and each group of base stations will be controlled by a Mobility Management Entity (MME) and a User Plane Entity (UPE).

The radio link 21 from the AP 20 to the MT 1 uses the same cellular telecommunication transport protocols as the conventional BS 3 but with a smaller range—for example 25 m. The AP 20 appears to the MT 1 as a conventional base station, and no modification to the MT 1 is required to operate with the AP 20. The AP 20 performs a role corresponding to that of

BS 3. This does not exclude that some variations are used e.g. in the protocols when connecting to AP 20 or BS 3.

Communications between the AP 20 and the core network 12 are preferably IP based communications, and may be, for example, transmitted over a broadband IP network (and routed via the Internet). The communications are routed via MSC 32 or SGSN 34. The AP 20 converts the cellular telecommunications transport protocols used between the MT 1 and the AP 20 to IP based signalling.

The connection 23 between the AP 20 and the core network 12 may use the PSTN telephone network. Typically a DSL cable connects the AP 20 to the PSTN (Public Switched Telephone Network) network. The data is transmitted between the access point 20 and the core network 12 by IP transport/DSL transport. The bandwidth of the cable connection between the access point and the telephone exchange is shared with multiple other users (typically between 20 and 50 other users).

The AP 20 may be connected to the core network 12 by means other than a DSL cable and the PSTN network. For example, the AP 20 may be connected to the core network 12 by a dedicated cable connection that is independent of the PSTN, or by a satellite connection between the AP 20 and the network core 12.

Furthermore, AP 20 may be connected to the core network 12 by means of BS 3 using radio link 21. In this case, AP 20 may appear as a mobile terminal from the point of view of BS 3 and BS 3 acts as a relay device for AP 20.

AP 20 would typically be configured to serve a Wireless Local Area Network (WLAN) located in a home or office, in addition to GSM/UMTS/LTE networks. The WLAN could belong to the subscriber of the MT 1, or be an independently operated WLAN. The owner of AP 20 can prescribe whether the AP is either open or closed, whereby an open AP is able to carry communications from any mobile device in the GSM/UMTS/LTE network, and a closed AP is only able to carry communications from specific pre-designated mobile devices.

The inventive idea will be described herein below with the aid of illustrative embodiments, which seek to improve radio resource management (RRM) in such a network. RRM involves strategies and algorithms for controlling parameters such as transmit power, channel allocation, handover criteria, modulation schemes, radio admission control, load balancing, packet scheduling, buffering and error coding scheme. The objective is to utilize the limited radio spectrum resources and radio network infrastructure as efficiently as possible.

Dynamic RRM schemes adaptively adjust the radio network parameters to factors such as the traffic load (e.g. to improve throughput), user positions, channel conditions, interference and quality of service requirements. Radio resource management (RRM) can be accomplished in a decentralised or a centralised manner. In a centralized arrangement, several base stations and access points are controlled by a core network element such as a Radio Network Controller (RNC), which manages the complete set of network resources. Other arrangements are distributed, using algorithms in mobile stations, base stations or wireless access points to autonomously distribute radio resources from within a given set of the overall resources. Alternatively, the network elements in the distributed arrangement may be coordinated by exchanging information amongst themselves. RRM is closely related to scheduling. The scheduler assigns radio resources within one cell or multiple cells to different users and data streams. For example, these resources could be resource elements, time slots, frequency bands, powers or codes. Some parts of RRM functionality can be accomplished by the scheduler. Specific examples of known RRM techniques include:
Link adaptation algorithms to control the modulation and coding on the radio link;
Selection and control of a spatial processing scheme such as spatial multiplexing, space-frequency block coding, or multiuser MIMO (multiple input multiple output)
Allocation of resources in a multi-hop relay system between different hops
Allocation of resource elements
Transmit power control algorithms;
Dynamic Channel Allocation algorithms;
Dynamic Frequency Selection algorithms;
Traffic adaptive handover criteria;
Admission control;
Load balancing

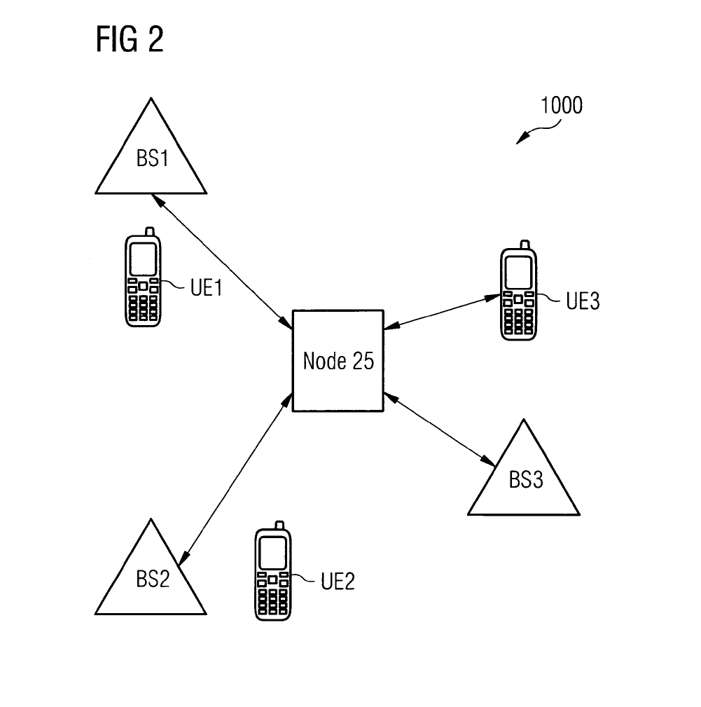

A centralised arrangement is shown in relation to FIG. 2, where base stations BS1, BS2 and BS3 communicate with a central node 25, which performs the RRM and is typically an RNC or MSC. It is to be appreciated that the central node 25 being an RNC or MSC is just one example configuration, and that other network element configurations are possible, such as the central node 25 being an eNode B in an LTE network. Similarly the base station nodes may be other small modular network elements, such as relay nodes.

According to a first illustrative embodiment of the invention, RRM is performed which takes account of energy parameters. The resource allocation is managed by at least one network device 3, 20 of a plurality of network devices in a mobile telecommunications network 1000 determining at least one energy dependent parameter in relation to each of the at least one network devices and then using the at least one determined energy-dependent parameter to make a resource allocation determination.

The network device 3, 20 has means that are arranged to determine the least one energy dependent parameter in relation to each of the at least one network devices present in the mobile telecommunications network 1000 as well as being also arranged to use the at least one determined energy-dependent parameter to make a resource allocation determination. These means can be implemented in hardware, for example using processors or other hardware implementations.

These energy parameters may relate to, for example:
energy consumption of each modular network element,
energy costs in relation to each modular network element's power supply; and/or
an energy reliability factor relating to each modular network element's energy source.

Energy parameters such as these can differ significantly in networks, particularly where modular network elements are incorporated which are not uniform in their construction and/or situation. For instance, where constructions are different, energy consumptions are likely to vary and where situations/locations differ, power supply reliability and cost may diverge.

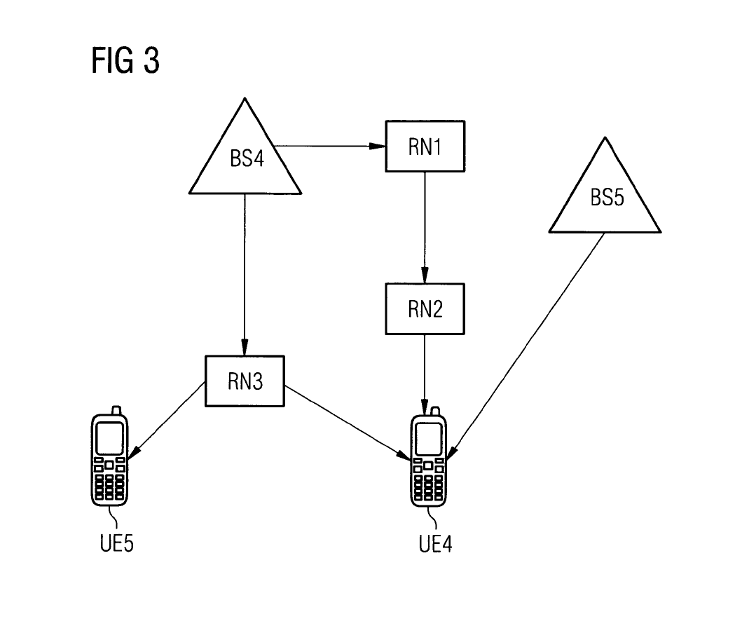

A further illustrative embodiment of the invention is shown in FIG. 3. Data is to be transmitted to UE4. There are different routing or scheduling possibilities. The direct link from BS5 to UE4 might be very weak—i.e. lots of radio resources (such as resource blocks) would be necessary and could not be used for other users in the cell served by BS5. Most link capacity and hence end-to-end data rate might be available if the signal is relayed from BS4 via a relay node (RN) in the figure by RN3 either through in-band or out-of-band relaying. However, RN3 might be powered from a solar-cell and is running at night time from a battery, or has another constraint on its available energy. Then the best way to route the signal might be the third alternative—routing the signal from BS4 via relay nodes RN1 and RN2 to UE4 provided enough network capacity is available and the energy supply of the intermediate relays RN1 and RN2 is guaranteed or at least sufficient. During day-time, when solar power is available and the batteries of RN3 are filled, data transmission can be transmitted from BS4 to UE4 via RN3 and higher data-rates might be achieved. UE5 has only a radio connection to the network via BS4 and RN3. Then, the limited amount of battery energy in RN3 should lead to switch to an energy-efficient transmission mode on the links BS4 to RN1 and RN1 to UE5. These energy parameters may be used in any of the known RRM techniques. They have particular utility in relation to assisting handover determinations.

Therefore, considering handover in this embodiment of the invention, with UE1 active and communicating through BS1. During this communication UE1 will be monitoring received signal strength measurements from BS1 in particular, as the serving base station. Once this signal strength measurement dips below a predetermined threshold, UE1 will commence sending its signal strength measurements for BS1 and other neighbouring base stations (i.e. BS2) to Node 25. Based upon these signal strength measurements, and one or more energy parameters, Node 25 will make any appropriate handover decisions.

The energy parameters may be at least one of the following:
predetermined fixed parameters (e.g. defined in a table associated with node 25);
measured at BS1 and communicated to Node 25 and/or
measured by another network element and communicated to Node 25.

Taking these energy parameters into account, BS2 may provide UE1 with the best signal strength measurements, but conversely also have a higher energy consumption parameter than BS1. Based upon this information, Node 25 will implement an algorithm which factors in this power consumption factor. For example, the algorithm may add a factor to the handover threshold, which in effect delays a handover to BS2 in order to reduce the energy consumption and conserve power. In this regard, Node 25 may implement an offset to the handover threshold, such that the offset is relative to the energy consumption parameter of BS2 (as long as that offset does not fall below a drop out signal limit for BS1).

In a variation of this embodiment, the energy use parameters are transmitted in a handover request message, so that the serving node can convey to the target node how much energy it expects to save, and correspondingly how much capacity the target node would need to release in order to effect the handover. This allows a sound decision to be made in order to minimise energy consumption, or to find a reasonable compromise between energy consumption and available capacity.

If the energy consumption is the bottleneck of the system rather than capacity it is better to deny service to some UEs (drop users or reduce their data rates) than handing them over to a node that may run out of energy more quickly if it has to serve that UE as well, because when that node eventually runs out of energy, this would cause even more severe degradation of the service later on.

In another embodiment, a distributed arrangement, UE1 takes one or more energy parameters into account in relation to its handover signalling threshold for commencing transmission of signal strength measurements to node 25. That is, this handover signalling threshold may also have an adjustment factor based upon the one or more energy parameters. For instance, if BS1, through which UE1 is communicating, has a low energy efficiency, this energy efficiency may be incorporated into the handover signalling threshold, such as via an offset component. This offset component would lower the threshold, resulting in the node 25 receiving the signal strength measurements at an earlier stage, and correspondingly being able to assess the overall network situation and instigate a handover to another node at an earlier stage. Conversely, for a highly energy efficient BS1, the threshold may be modified by increasing it. In this situation, the UE1 will be communicating through BS1 for a longer period of time, and accordingly would ensure that UE1 does not report unnecessary handover measurements to node 25. This improves also the energy consumption efficiency for UE1.

In addition to utilising such parameters in relation to handover decisions, these parameters may also be taken into consideration when designing an overall network operation and/or during real-time network management and operation. For example, in a mesh network or a relay network involving multiple hops, the parameters could be used by a scheduler in choosing appropriate network elements or in devising a suitable route for a communication through the network, or at least the most appropriate “next hop”. In this way, the energy parameters can be used to minimise the overall energy consumption.

Examples of energy parameters for each network element that may be measured/determined and used alone or in combination with another, in the RRM include:
remaining battery power;
energy reliability classification (for network elements located in a country/region with low power reliability (e.g. India), a low reliability classification may be applied);
energy cost (especially if different energy sources with different costs are available throughout a network, such as mains possibly with different costs due to different contracts, diesel generated power, wind generated power, solar generated power or battery supplied power, also taking into account that even the same energy source may cause different costs, e.g. mains may be charged differently due to different contracts, diesel powered sites may have different capacities of the tank and therefore the refuelling costs and costs for hauling the diesel (which themselves might differ for different sites) will be distributed on different amounts of diesel and different aggregates may differ in their power conversion efficiency);
expected power supply availability (e.g. time of day for solar-powered radio network elements).
average and/or peak power consumption of each network element;
energy consumption of different operational modes of a network element (e.g. spatial processing for frequency diversity schemes, discontinuous transmission (DTX) mode, number of antennas/antenna elements (e.g. RF chains) used for transmission and reception;
energy consumption for different quality of services that a user can require
energy consumption for different users served; and
energy consumption patterns through the day (e.g. taking into account less activity at night).

These energy parameters typically take into consideration the power supply consumption of modular network elements, as well as the energy supplied to those network elements.

In order to have a consistent energy comparison between network elements, particularly where there is more than one parameter for each element, it is preferable that the energy parameters for each network element are combined into a single unified energy indicator. Preferably this indicator takes the value of one if there are no energy constraints and the value of zero if there are full energy constraints (e.g. no power available). This may be achieved by using an energy algorithm which is common to all network elements, and which is normalised. For example, let us assume the first networks element runs with solar or wind power and has its battery fully charged, then the cost of energy it uses in particular the incremental cost when it uses more energy is basically free and the parameter is 0. Another network element uses energy that costs say 5 price units per kWh (Kilo Watt hour), and a third one an energy source that costs 8 price units per kWh. These prices cannot be put into relation immediately, but need to be normalized. The two network elements could require a different amount of energy to transmit a desired data rate or a single resource unit, so the costs will have to be normalized accordingly. E.g. if the second network element only requires half the energy, the cost relation is not 5:8 in favour of the first, but 5:4 in favour of the second network element. Further more, if the energy costs per resource unit or data rate was exceeding a certain threshold value, then operation is pointless because the money spent for energy cannot be earned back by selling the service, so it is more cost efficient not to provide the service but to refuse admission (admission control). The threshold value can be used to normalize the energy parameter: It is 1 if the energy cost exactly corresponds to the threshold, it is the quotient of the actual cost divided by the threshold if the actual cost is below the threshold, in this case the parameter is below 1. It is 0 if the (incremental) energy cost is 0 as well. If the cost exceeds the threshold, or if no energy is available at all, the parameter can be set to 1 as well, as in all these cases it is best (or only possible) not to provide any service.

In this regard, the energy parameters may be managed by node 25 using a table which combines all of the relevant factors in relation to each network element. For instance, the following Table 1 is an example of energy factors that could be taken in to consideration for BS1:

TABLE 1

| | Determined | Weighting |
|---|---|---|
| Energy Parameters | Value | Factor |
| Battery power level | 10% | 0.1 |
| Device energy classification | Rating 1 | 0.2 |
| Energy Cost | 0.05 p per | 0.05 |
| | kilowatt | |
| Expected activity level | 70% | 0.7 |
| DTX mode consumption rate | 0.02 W | 0.9 |
| Operating mode consumption rate | 1000 W | 0.5 |

Each of these energy parameters may be incorporated in to the single unified energy indicator using a weighting factor determined for each component. Preferably the weighting factors/parameters are utilised in an appropriate algorithm that balances the various factors against each other.

Depending upon the energy parameters used to create the unified energy indicator, the indicator may provide a measure of the available energy per unit cost.

The look up table may also provide energy consumption estimates per transmitted bit for different operational modes. Where this information is provided, Node 25 could then select an appropriate operational mode of the network element, depending on the needs for the network in terms of energy conservation. These operating modes could be different coding and modulation formats or spatial processing schedules, or different operating bandwidths in a system with flexible bandwidth allocations.

As a further illustrative example of how these energy parameters may be used in RRM, if the node 25 determines, as per Table 1, that BS1 has a low battery status, the node 25 may use this information in a decision to allow only users assigned to BS1 that cannot be reached at all by any other network element, to continue to use BS1 in order to minimise the power usage of BS1. Alternatively, or in addition, the node 25 may instruct BS1 to operation in the most energy efficient operational mode. For instance, BS1 could use a power efficient spatial processing mode and/or maximise its use of Discontinuous Transmission (DTX), which is a method of momentarily powering down, such as during periods where there is no information to transmit. Modern communications systems such as mobile WiMAX or 3GPP LTE support multiple transmit and/or receive antenna elements enabling a variety of spatial processing modes. The spatial processing modes have different energy consumption. In one example, the usage of more than one transceiver or transmitter antenna and radio frequency chain may imply a much higher energy consumption and should be avoided from an energy consumption perspective. In another example, the time to transmit a certain number of data bits might be short if multiple antennas are activated—minimizing the total energy to transmit these bits successfully. These examples illustrate that energy consumption prediction is complex and using tables could be an efficient way.

In another embodiment of the invention, knowledge of traffic conditions is used in order to minimise, or at least reduce, energy consumption. In this regard, node 25 may be associated with one or more look-up tables defining various power consumption/supply values for different situations. For example, look-up table may define the probability of activity through the day for a particular network element (BS1), such as is shown in Table 2 below:

TABLE 2

| | PROBABILITY OF | ACTIVITY |
|---|---|---|
| TIME OF DAY | ACTIVITY | FACTOR |
| 12.00 am-5.59 am | 10% | 0.1 |
| 6 am-11.59 am | 70% | 0.7 |
| 12 pm-5.59 pm | 90% | 0.9 |
| 6 pm-11.59pm | 50% | 0.5 |

The activity table can be learned from previous network activity, programmed to a default value by the network operator or signalled by the core network. Table 2 is just an exemplary table, and other probability values and time of day segments (e.g. for each hour of each day of the week) may be used.

One option of implementing the probability values is to have an “activity factor” defined for each time of day segment (e.g. as shown in Table 2) on a scale between 0 and 1. A factor of 1 would indicate that the probability of activity is certain, and the element should be in a fully on mode. Conversely, a factor of 0 would indicate very low probability of activity and in normal situations would allow the particular network element to which the probability applies, to be powered down to the lowest availably energy saving mode. Similarly, expected periods of low activity (e.g. 0.1 to 0.4) would provide node 25 with the opportunity to operate applicable network elements in DTX mode, for example. In this way, Table 2 advantageously enables the node 25 to reduce the energy consumption of particular network elements in non-busy periods of the day or night. The patterns of activity may be defined on a weekly, monthly, yearly or other seasonal basis. In this way, energy consumption is considered to an extent that is not detrimental to capacity.

These activity weightings could also be used by the network for other purposes. For instance, should the core network/node 25 identify unusual activity (e.g. arising from a localised event or emergency situation) the activity factor for network elements in the vicinity could be increased to a probability 1, indicating that the elements should remain active regardless of the other factors related to energy.

Activity factors between 0 and 1 could be used as an additional scaling factor to the energy weighting of Table 1. The energy indicator and (1-activity factor) may be combined utilizing appropriated weighting factors. Energy indicator equals to 1 and low activity factor may indicate that there are no energy constraints while indicator equals to 0 and high activity factor may indicate there is no power available. If the node 25 determined, as per Table 1, that BS1 has low battery status but it is expected, as per Table 2, that the activity of BS1 is going to decrease, the node may use this information in a decision not to handover users assigned to BS1.

In a further illustrative embodiment of the invention, the situation of a UE having multiple air interface options and choosing an appropriate one is addressed using energy parameters. In this regard, the UE has the capability of moving among different types of wireless networks, such as between a WLAN (e.g. Bluetooth or IEEE 802.11) and a mobile telecommunications network (e.g. GSM or UMTS). To implement this embodiment, the node 25 has data relating to the necessary energy parameters which relate to the interface, allowing the node 25 to select the most appropriate one based upon the service required by the UE and of course the relative energy efficiencies. This concept of a unified energy indicator therefore simplifies signalling, RRM and allows a simplified selection between different air interfaces to take place. From a methodology point of view the same approach can be used as explained for the handover decision. The difference is that it is now a handover between the multiple interface options. Even though this is not necessarily a handover, the methodology presented above can still be applied.

In a further embodiment of the invention, the modular network elements (i.e. access points and/or relay nodes) are classified according to energy status, such that the classes are based upon energy parameters and/or traffic measurements. This allows, for example, the available charge of the batteries of the modular network elements to be predicted using the expected traffic at a certain time segment. For instance, during the day, a relay node with a low battery connected to a solar panel and only slightly loaded may be in the same group as a relay node with a full battery but connected to wind turbines on a windless day. Then if a group of network elements are considered to be running low on charge, node 25 can divert usage away from those elements, where possible and feasible. A charge factor indicating the available level of charge of a battery, can be a combination of the availability of the power supply and of the traffic activity at different times of the day. Such a scaling factor can then be added to the energy weighting of Tables 1 and 2. A single unified energy parameter may then be applied within each class as described below.

The classification of the network elements is preferably performed dynamically. The classification may also be performed in a centralised manner, for instance where node 25 dynamically assigns a network element to a class on the basis of energy information received and expected user traffic demand. Alternatively, classification may be performed in a distributed manner so that, for instance, where a network element needs to change class (e.g. due to an excessive use of its available power) can negotiate with its neighbouring network elements. With such dynamic classification, it becomes possible for network elements with differing characteristics to be in the same class where they have similar power availability at a particular time.

Then, a unified energy indicator can be applied to RRM considerations, such as handover. In this situation, the unified energy parameter may be applied as an offset to the handover threshold. Similarly the handover measurement trigger conditions can be adapted accordingly, in order to ensure that a UE does not report unnecessary handover measurements, where the threshold has been modified.

A particular advantage of the embodiments of the invention which rely on updatable energy parameters is that such energy parameters change relatively slowly over time (i.e. in a minute or hour timescale rather than a millisecond timescale). Since the parameters are not constrained by tight time scales, the signalling overhead for these energy parameters can be quite low. In this regard, signalling of energy parameters may be accomplished by any suitable means, including using the control plane, either within a communication standard, or on an IP packet layer outside the actual wireless standard (e.g. leveraging the X2 interface in LTE). The delay is higher in the IP connection example, but still acceptable for the minute/hour timescale of the energy parameters. In a further alternative, the energy parameters may be broadcast on the Over the Air (OTA) interface, in a manner that allows surrounding network elements to take these energy parameters into account.

These embodiments of the invention have particular application to small modular network elements, because, due to their nature of being not wholly under the control of the network provider, their power state can be unreliable, and therefore are likely to benefit from careful power management. For instance, for network elements with alternative power supplies, such as solar panels, battery or capacitor-based local power storage, wind turbines and the like, by carefully managing the usage of the power available to these network elements, a reliable and constant operation of the elements can be obtained.

Also the embodiments of the invention have the ability to reduce power consumption, resulting in cost saving benefits and also a reduced environmental impact. This is additionally advantageous where the power supplied to the elements is costly and utilities companies are unwilling to negotiate an improved cost basis.

Furthermore, the herein disclosed invention may be realized by means of a computer program, respectively software. However, the herein disclosed invention may also be realized by means of one or more specific electronic circuits, respectively hardware. Furthermore, the herein disclosed invention may also be realized in a hybrid form, i.e. in a combination of software modules and hardware modules. A suitable processor can be adapted to execute the inventive method. As used herein, reference to a computer program is intended to be equivalent to a reference to a program element and/or a computer readable medium containing instructions for controlling a computer system to coordinate the execution of the above described method. The computer program may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions.

Although the embodiments of the invention has been described in relation to communications between one NodeB 25 and multiple small modular network elements (i.e. BS1, BS2, BS3), the embodiments may equally be applied to multiple macro base stations and one or multiple modular network elements.

The embodiments of the invention have been particularly described in relation to their application to modular network elements in a communication network. The principles of the invention, however, may readily be applied to other network elements, including macro base stations. Further, the principles of the invention may also be applied to various forms of communication networks, including IEEE 802.16j, IEEE 802.16m, LTE-Advanced networks, sensor node networks and ad-hoc networks.

Although the invention has been described in terms of preferred embodiments and refinements described herein, those skilled in the art will appreciate other embodiments and modifications which can be made without departing from the scope of the teachings of the invention. All such modifications are intended to be included within the scope of the claims appended hereto.

1. A method of managing resource allocation in at least one network device of a plurality of network devices in a mobile telecommunications network comprising the steps of:
determining at least one energy dependent parameter in relation to each of the at least one network devices; and
using the at least one determined energy-dependent parameter to make a resource allocation determination.

2. A method according to claim 1, further comprising the steps of:
determining at least one network traffic dependent parameter; and
using the at least one determined network traffic dependent parameter to make the resource allocation determination.

3. A method according to claim 1 wherein the determined energy dependent parameter comprises at least one of:
a) an energy consumption parameter relating to each network device;
b) an energy cost parameter relaying to each network device's energy source;
c) an energy reliability factor relating to each network device's energy source.

4. The method according to claim 1 wherein the determined energy dependent parameter comprises at least one of:
a) a power level of a battery of each network device;
b) an energy reliability classification for each network device;
c) a cost of energy supplied to each network device;
d) an estimated future power supply for each network device;
e) an average power consumption of each network device;
f) a peak power consumption of each network device;
g) an estimated energy consumption for different operational modes of each network device;
h) an estimated energy consumption for different quality of services that a user can require
i) an estimated energy consumption required to serve one or more particular users; and
1) an estimated energy consumption pattern over a given time period for each network device.

5. A network device adapted for managing resource allocation in a mobile telecommunications network having means arranged to execute the steps of method claim 1.

6. A network device according to claim 5, wherein said network device is at least one of the following: an access point, a base station, a nodeB, an enodeB.

7. A mobile telecommunications network comprising at least one network device according to claim 5.
